(19) United States
(12) Patent Application Publication
(10) Pub. No.: US 2003/0164821 A1
(43) Pub. Date: Sep. 4, 2003

(54) Writing instrument with variable display

(76) Inventor: Omid Rezania, Watertown, MA (US)

Correspondence Address: Omid Rezania, First Floor, 67 Commonwealth Road, Watertown, MA, 02472, US

(21) Appl. No.: 10/357,923

(22) Filed: Feb. 4, 2003

Related U.S. Application Data
(60) Provisional application No. 60/354,037, filed on Feb. 5, 2002.

(51) Int. Cl. G09G 5/00

(52) U.S. Cl. 345/179

(57) ABSTRACT

A writing instrument is described which comprises of an electronic display unit, and the said unit may display various visual effects when activated by the user.

### RELATED APPLICATION

This application claims priority to U.S. Provisional Patent application No. 60/354037 filed Feb. 5, 2002 the contents of which are incorporated herein by reference to its entirety.

### BACKGROUND

A large part of the writing instruments used globally have text or graphics printed on their outer shell. For instance, in many exhibitions or commercial events, participating firms give away pens which bear their advertisement on the body of the pen.

Even though there exist numerous applications for a writing instrument on which the displayed content may be programmed and be variable, until recently the required technology for such device did not exist.

The present patent application presents an invention that allows multiple texts or other graphic/visual effects to be displayed on the body of the writing instrument (or inside a writing instrument with transparent shell). These visual effects may be preprogrammed and a new visual effect (or a sequence of the said visual effects) may be displayed each time the user of the writing instrument performs a particular function (e.g. pressing the push button on the writing instrument).

### BRIEF SUMMARY OF INVENTION

The invention comprise of a writing instrument with the following units:

1. An electric power unit, which may include battery and/or other components such as commercial piezoelectric component.

2. An electronic micro controller unit

3. An electronic display unit which may display predetermined visual effect (text, graphics or combination thereof).

The electric power unit provides the electric power needed by other units in the invention. The micro controller unit comprise of a commercial memory chip and the driver for the display unit.

Once the micro controller receives the signal from the user (through user pushing a button, or other functions), it may retrieve a particular set of stored data whereby determining the visual effect to be displayed, and the display driver may then display the said visual effect.

Variations of the invention may include additional components—such as electrical capacitive element, electronic clock, etc.—which may enhance the above function. In one embodiment, rather than a single visual effect, a succession of visual effects may appear on the display panel each time the invention is activated (e.g. user presses the push button).

### BRIEF DESCRIPTION OF THE DRAWINGS

The drawings are not to scale, emphasis instead is placed on illustrating the principles of the invention.

FIG. 1 is a schematic drawing of the particular embodiment of the invention described in the “Detailed Description of an Embodiment”.

FIG. 2 is a schematic drawing of an embodiment of the invention, where the display unit is mounted on the outside surface of the writing instrument.

### DETAILED DESCRIPTION OF AN EMBODIMENT

The embodiment comprises of the units described below.

### Electric Power Unit

This embodiment uses a piezoelectric element to generate electricity. Piezoelectric devices utilize a piezoelectric material—usually a ceramic—and are typically of crystalline nature. Once pressure is exerted on this material—typically along a particular crystalline axis—a voltage difference is produced. This in turn leads to an electric current. The amounts of the voltage difference and current are dependent on a number of parameters including the material characteristics of the piezoelectric element and the amount of pressure.

In this embodiment, a piezoelectric element commercially available through Stelco Gmbh (http://www.stco-stettner.com/e_index.htm) may be used.

### Micro Controller Unit

The micro controller unit comprises of a nonvolatile programmable memory chip and the display driver. Both the said memory chip and the display driver are available commercially as off the shelf products and can be obtained as an example from the suppliers to the personal computer industry. The chip may also be designed and manufactured specifically for this invention as an application specific integrated circuit (ASIC) or other means with similar function.

The predetermined patterns to be displayed on the display unit are stored initially in the memory chip of the micro controller. The patterns may be stored in digital form and determine which set of pixels are to be turned on (activated) and which ones to be turned off (deactivated). The collection of the activated pixels on the display unit determine the final visual effects to be displayed. The said chip sends the data to the display driver. Display drivers control the pixels on the display unit, whereby controlling the content to be displayed.

In this embodiment, a commercially available active matrix driver may be used. The said driver is the same driver used in many products, such as many electronic organizers.

### Display Unit

The display unit comprise of a commercially available display panel. In this embodiment, an electronically addressable display is used. Electronically addressable display devices—such as commercial products of the firm Eink—www.eink.com—are typically flexible, are thin and have low power requirement. Due to the specific technology used, the displayed object—e.g. picture, text, graphics, or other combinations thereof—will remain displayed until the panel is activated again. In other words, each pixel of the display unit will retain its state even if the power is not supplied to the display unit any longer. The displayed object would change only when it is once again activated by the electrical current sent from the controller unit. The electronically addressable display can be implemented, as an example, using a system and method shown in U.S. Pat. No. 6,120,588 incorporated herein by reference to its entirety. The Eink display requires active matrix thin film transistor (TFT) as driver, and the said driver is commercially available. The voltage provided by the piezoelectric element is sufficient for use with the said display.

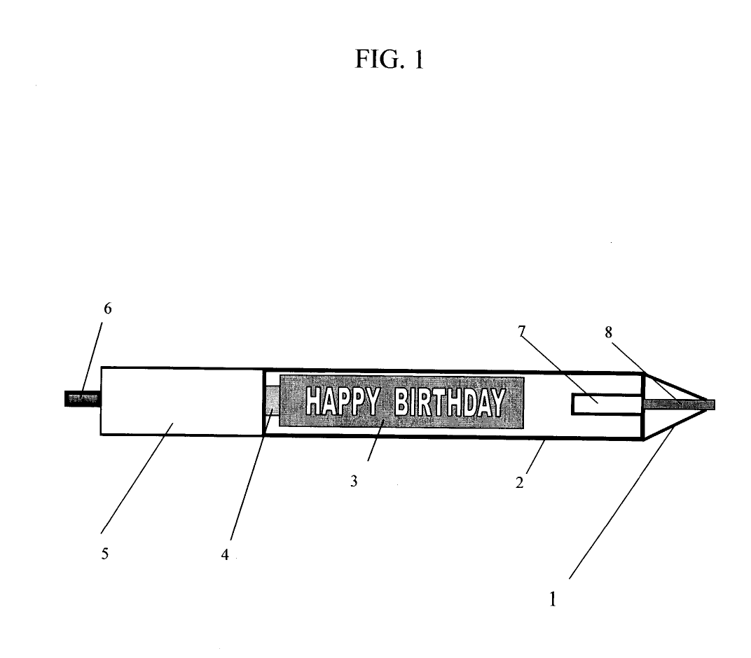

In FIG. 1, the display unit, mounted on the inside of the body of the writing instrument, shows a previously programmed visual effect. Once the user presses the push button, this pressure is transferred via mechanical elements inside the pen to the piezoelectric element. This induces stress in the piezoelectric material, which in turn generates voltage difference and electrical current. The current is transmitted to the micro controller by means of commercial electrically conductive material. The micro controller then sends the appropriate signal to the display panel to activate certain pixels and deactivate others, whereby producing a new visual pattern.

Commercial writing instruments exist which comprise of batteries and a light emitting diode (LED). Examples of the aforementioned writing instruments are pen lights available at www.promobrands.com. Once the user pushes on the button at one end of this writing, the power (generated by batteries) is transmitted to the LED, whereby lighting the diode. Similar arrangement may be used in this embodiment for position and transmission of electric power to the micro controller unit. In case of the invention, the micro controller unit may replace the LED and the piezoelectric element may replace the batteries as the source of electric power.

### Assembly of Units

FIG. 1 is the schematic drawing of a pen, in which the twisting motion of part of the pen will protrude or retrieve the writing tip of the pen, and the display unit is activated by means of a push button. Item 1 is a schematic drawing of the part of the invention which may be twisted by the user to protrude or retrieve the writing tip. Item 2 is a schematic drawing of the transparent shell, which encloses internal parts of the invention. Item 3 is a schematic drawing of the display unit. Item 4 is the schematic drawing of the micro controller unit. Item 5 is a schematic drawing of the electric power unit. Item 6 is a schematic drawing of the push button. Item 7 is a schematic drawing of the ink cartridge. Item 8 is a schematic drawing of the writing tip of the pen.

The electric power unit may be placed inside the writing instrument, between the push button and the remaining components. The electric power generator unit may be glued or soldered to the body of the writing instrument, or may be attached using other means of attachment.

The electric power unit is then connected via electrically conductive material to the micro controller. The micro controller may be positioned any where inside the writing instrument, as long as it doesn't interfere with the normal operation of the writing instrument. It may also be positioned outside the writing instrument's outer shell in a separate compartment. The micro controller unit may be glued or soldered to the body of the writing instrument, or may be attached using other means of attachment.

In this embodiment of the invention, the user exerts a twisting motion to part of the instrument to protrude and retract the writing tip, and uses a push button to switch on the electrical power unit and the display.

### Some Variations of the Invention

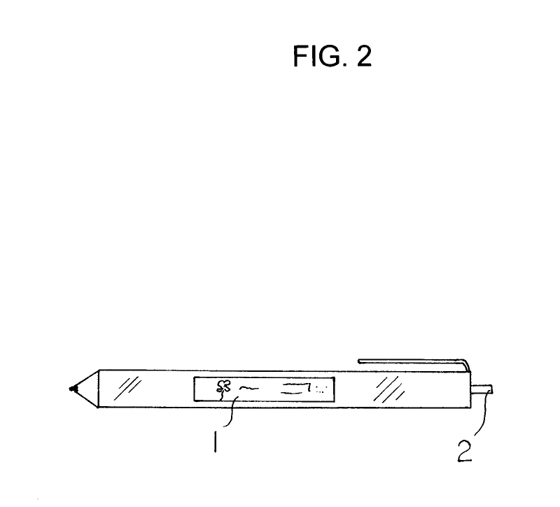

The display unit may be attached to the outside of the writing instrument, for instance attached to the barrel (see FIG. 2). The micro controller unit is connected to the display unit (item 1 in FIG. 2) using commercially available electrical conductors. In this embodiment, the design of the writing instrument is that of a commercial push button writing instrument augmented to accommodate for the display unit, electrical power unit and the micro controller unit. In this embodiment, each time the push button (item 2 in FIG. 2) is pressed, a new visual effect (text, graphics or combination thereof) may be displayed on the display unit. In this embodiment, a flexible electronic display device may be used. One such display device is electronically addressable display device—such as commercial products of the firm Eink (www.eink.com)—which are typically flexible and may conform to the curvature of the outside of the writing instrument.

The visual effects to be displayed may be one set of patterns (e.g. texts on a particular subject) or a succession of various visual effects. User may have means of choosing the set of patterns to be displayed. For instance the invention may include a rotating element attached to the writing instrument (e.g. a ring attached to the outside of the writing instrument), and the user may pick the required selection by rotating the said element, whereby closing the corresponding circuits in the micro controller. Each circuit may activate the display unit differently, whereby displaying the corresponding visual effect.

The invention may use micro electromechanical systems (MEMS) as the sole source of electrical power, or to augment another source of electrical power. One example of such MEMS device (namely micro power generator) is produced at DARPA (www.darpa.mil/mto/mems).

Some writing instruments use a twisting motion as part of the instrument to protrude the writing tip of the instrument—i.e. tip of the ball point pen, lead of the pencil, etc. In such cases, this rotating motion may be used as the source of energy for the invention. This may be used by a spring mechanism, MEMS, electronic capacitive elements, or combination of these, or similar means of converting the rotational mechanical energy into electrical energy.

Battery may be used in the power unit to augment the other sources of energy described so far—i.e. piezoelectric element, MEMS, or similar means—or to replace them. As an example, a system may be used which uses a piezoelectric element in the electric power unit (for instance to achieve high voltage difference), and also batteries to increase the amount of electrical energy. Such a system may be designed in the following variations or combinations thereof:

Push button retracting writing instrument with batteries:

One embodiment of the invention may be a writing instrument which uses a push button to protrude and retract the writing tip, and incorporates batteries in the body of the writing instrument. Pushing the button may also switch the micro controller unit on—i.e. send current to micro controller to activate that unit—or the activation of the micro controller may be performed separately.

Twisting writing instrument with batteries:

One embodiment of the invention may be a writing instrument which uses twisting action to protrude and retract the writing tip. The twisting action may also act as a switch to turn on the electric power unit. There may also be other means of switching to start the power generation, and use the twisting motion only to protrude/retract the writing tip. Another variation is using the push button to protrude and retract the tip, and use twisting action to power the invention. Another variation is using both push button and rotating mechanisms as sources of energy for the invention.

Use of piezoelectric element and battery

One embodiment of the invention may be a writing instrument with push button, in which pressing the button will press on the piezoelectric element. The current produced by the piezoelectric element may be increased by using one or more batteries.

There are commercial writing instruments which include a sound generating element. For instance, once the user performs a specific act (e.g. pressing the push button on the end of writing instrument), a particular sound is generated using the incorporated sound generation unit. Such technology may be used in conjunction with the invention.

Bluetooth wireless technology allows various products to communicate with each other, and transfer data from one to the other. The invented device may comprise of a Bluetooth element, whereby the device would receive data from another Bluetooth product. The received data may be used to over write the programmed data stored in the micro controller unit, or modify it. One may refer to commercial examples of Bluetooth by visiting www.bluetooth.com. The invented device may comprise of the appropriate Bluetooth component, chosen based on the power requirement of the said component and technical specifications of the display unit, and available electrical power. The Bluetooth component may be positioned inside or outside the writing instrument, and may be connected to the micro controller using commercial electrical connections.

What I claim as my invention is:

1. A writing instrument comprising of:
an electric power unit; and
a micro controller unit; and
an electronic display unit; and
electrical connections between the aforementioned units,
whereby the electronic display unit being attached to the writing instrument displays visual effects determined by the micro controller unit.

2. A device comprising of device in claim 1, and a bluetooth component whereby the said blue tooth component receives the wireless signal and communicates with the micro controller unit, and the micro controller unit display visual effects not previously programmed in the micro controller or alter the said programs.

3. A device comprising of device in claim 1, and sound generating components, whereby the invention may generate sound in addition to displaying visual effects.
